(19) United States
(12) Patent Application Publication
(10) Pub. No.: US 2007/0189344 A1
(43) Pub. Date: Aug. 16, 2007

(54) Modulator-integrated light source and its manufacturing method

(75) Inventors: Kenji Sato, Tokyo (JP); Koji Kudo, Tokyo (JP); Tomoaki Kato, Tokyo (JP); Hiroaki Chida, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/590,029

(22) PCT Filed: Feb. 16, 2005
(86) PCT No.: PCT/JP05/02318

§ 371 Date: Aug. 18, 2006

(30) Foreign Application Priority Data
Feb. 20, 2004 (JP) 2004-044590

(51) Int. Cl. H01S 3/10; G02F 1/03

(52) U.S. Cl. 372/26; 359/245

(57) ABSTRACT

An inexpensive and compact modulator-integrated light source is capable of obtaining an extinction ratio of 10 dB sufficient for use in optical communication without requiring an amplifier or temperature regulating mechanism. The modulator-integrated light source is composed of a semiconductor laser and modulator integrated on high-resistance semiconductor substrate 1. The electroabsorption optical modulator has P-electrode 14 and N-electrode 32 which are arranged on one surface of high-resistance semiconductor substrate 1 and to which a prescribed bias voltage is applied, and the electroabsorption optical modulator is constructed to satisfy the condition: L×B≧2000 μm·Gb/s, where L is the length of the electroabsorption optical modulator and B is the operating frequency.

### TECHNICAL FIELD

The present invention relates to a modulator-integrated light source in which a semiconductor laser and an electroabsorption optical modulator are integrated on the same substrate, and more particularly to a modulator-integrated light source that operates at low voltage and over a broad temperature range in the 1.3 μm band or 1.55 μm band used in optical fiber communication.

### Background Art

Development is progressing toward the practical use of a modulator-integrated light source as a light source for optical fiber communication in which a distributed feedback laser (DFB-LD) and an electroabsorption modulator (EA modulator) are integrated on the same semiconductor substrate. Such a modulator-integrated light source has a low level of wavelength fluctuation during modulation and is therefore used principally as the light source for mid- and long-distance high-volume optical fiber communication.

An EA modulator of multi-quantum well (MQW) structure is normally used in a modulator-integrated light source. In the EA modulator of MQW structure, the application of a reverse bias voltage causes the absorption end of excitons to shift to the long wavelength side (low-energy side) due to the quantum confined Stark effect, thereby realizing absorption (extinction) of continuous wave (CW) light from the distributed feedback laser (refer to page 7 and FIG. 8 of Document 1 (JP-A-2003-60285)).

FIG. 1 is a schematic representation of the configuration of a standard example of a modulator-integrated light source of the prior art. Referring to FIG. 1, the modulator-integrated light source is of a configuration in which a laser section and modulator section are formed on the same n-InP substrate 31. Waveguide layer 5 and n-InP clad layer 7 are formed extending in the waveguide direction on n-InP substrate 31 with high-reflection coating 16 formed on one end surface and low-reflection coating 17 formed on the other end surface. A portion of the interface of n-InP substrate 31 and waveguide layer 5 has diffraction grating 3 provided with a λ/4 phase shift structure 4. Active layer (quantum well) 6 of the laser section and active layer (quantum well) 11 of the modulator that are formed in proximity to the waveguide direction are included between waveguide layer 5 and n-InP clad layer 7. P-electrode 9 is formed on n-InP clad layer 7 with cap layer 8 interposed, and P-electrode 14 is formed on n-InP clad layer 7 with cap layer 13 interposed. Cap layer 8 and P-electrode 9 constitute the laser section, and cap layer 13 and P-electrode 14 constitute the modulator section, and these sections are separated by electrode separator 15. N-electrode 32 that confronts P-electrodes 9 and 14 is formed on the rear surface of n-InP substrate 31.

In the above-described modulator-integrated light source, the modulator section is an EA modulator in which the electroabsorption effect is applied, this effect being produced by the change in absorption coefficient caused by an electric field; and the laser section is a distributed feedback laser. In the modulator section, the application of a reverse bias voltage between P-electrode 14 and N-electrode 32 results in the absorption (extinction) of the CW light from the distributed feedback laser due to the above-described quantum confined Stark effect. Optical modulation is realized by using this absorption action.

One important feature demanded of a modulator-integrated light source is modulation speed. The chief factor that limits modulation speed is the electrostatic capacitance of the electrode pads and active layer in the modulator section. When a modulation speed of, for example, 10 Gb/s (gigabit/second) or 40 Gb/s is to be realized, the modulator length L is normally shortened to reduce the area of the modulator and thus realize the greatest possible reduction of the electrostatic capacitance of the active layer. More specifically, the modulator length L is set to 160 μm if the modulation speed is 10 Gb/s, and the modulator length L is set to 40 μm or one-fourth the previous value if the modulation speed is 40 Gb/s. When the modulator length is shortened, a large voltage must be applied to the modulator to obtain a sufficient extinction ratio (ON/OFF ratio), and this in turn necessitates a driver circuit to supply this large voltage.

An integrated optical modulator that achieves a further decrease in electrostatic capacitance is described in the Document 2 (page 5 and FIG. 2 of Japanese Patent No. 2540964). This integrated optical modulator uses a high-resistance substrate in place of the normal N or P-type conductive substrate, and is of a configuration in which the pads of the P-electrode and N-electrode are not opposed. This configuration enables a reduction of the electrostatic capacitance of the electrode pad portions, and residual electrostatic capacitance therefore occurs only in the active layer section. Accordingly, a major reduction of electrostatic capacitance C is obtained and the modulation bandwidth, which is determined by a CR time constant, is dramatically improved.

Along with modulation speed, another important characteristic demanded of a modulator-integrated light source is the extinction ratio. A modulator is normally configured such that absorption occurs in the presence of an electric field but does not occur when the applied voltage is 0V, and the energy band gap of the absorption layer (MQW) of the modulator and the oscillation wavelength of the distributed feedback laser are set such that good absorption can be obtained. If the oscillation wavelength of the distributed feedback laser element is λ and the gain peak wavelength of the optical modulator is λ0, the detuning amount Δλ (=λ−0), which is difference in wavelength between these wavelengths, is an important parameter for setting the absorption property.

Document 1 describes the relation between the detuning amount Δλ and the optical absorption spectrum. In setting the detuning amount, the amount of inserted loss and the level of the operating voltage are in a trade-off relation. It is known from the prior art that setting the detuning amount to 50-70 nm maximizes the extinction ratio. The higher the extinction ratio, the higher the degree of light modulation with respect to the modulation voltage. This relation indicates the suitability of a low-voltage drive. However, because the drive voltage amplitude of the modulator must be set to 2-3V in order to obtain an extinction ratio of at least the 10 decibels that is sufficient for use in optical communication, a driver is normally required for amplifying the voltage amplitude (less than or equal to 1V) of peripheral logic circuits.

The anticipated operating temperature of the modulator-integrated light source is also an important factor in setting the detuning amount. Typically, the higher the operating temperature, the more closely the absorption peak wavelength of the modulator will approach the oscillation wavelength of the distributed feedback laser. Since the detuning amount thus decreases as the operating temperature rises, a device such as a Peltier element is normally used to keep the temperature uniform and maintain a uniform detuning amount so that the maximum extinction ratio can always be obtained.

The detuning amount may be expressed as either the wavelength difference (nm) or the energy conversion value (meV). The formula for converting the wavelength difference to the energy difference is:
energy (eV)=1.24/wavelength (μm)
According to this conversion formula, when the wavelength difference 50-70 nm is set in, for example, the 1.55 μm band as the detuning amount for obtaining the maximum extinction ratio, the energy conversion value is 27-38 meV.

When the detuning amount is expressed by the energy conversion value (meV), the detuning amount can be expressed as a universal value regardless of the wavelength band. However, in different wavelength bands, the energy conversion values will each differ even for a detuning amount (nm) of the same wavelength difference. For example, in the 1.55 μm band, a detuning amount of 50 nm as the wavelength difference will be 27 meV as the energy difference, while in the 1.3 μm band, a detuning amount of 50 nm as the wavelength difference will be 38 meV as an energy difference. Physically, when the detuning amounts are equal as energy conversion values, the characteristics will be equal regardless of the wavelength band. As a matter of convenience, the detuning amounts are all expressed as energy conversion values in the following explanation.

A modulator-integrated light source that realizes non-temperature modulated operation is described in Document 3 (Milind R. Gokhale, “Uncooled 10 Gb/s 1310 nm Electroabsorption Modulated Laser,” Optical Fiber Communication 2003, March 2003, Post-Deadline paper PD-42 (page 1, FIG. 3)). This modulator-integrated light source maintains its extinction characteristics regardless of changes in the detuning amount that result from temperature by changing the offset voltage of the optical modulator according to these changes. In this case, the offset voltage is the central voltage of a modulation voltage signal that is applied to the modulator and is usually regulated by the applied voltage when 3-decibel portions of light are absorbed in the modulator. According to the configuration described in Document 3, due to increases in the detuning amount particularly in the range of low temperatures, the offset voltage of the modulator that is required for extinction rises as high as 4 V or more.

### DISCLOSURE OF THE INVENTION

The modulator-integrated light sources of the above-described prior art have drawbacks as described hereinbelow.

In the modulator-integrated light sources that are described in Documents 1 and 2, the operating voltage of the modulators is high and amplifiers (drivers) are therefore required for obtaining this operating voltage. For example, in a typically employed modulator-integrated light source (for example, for 10 Gb/s) in which the modulator length is on the order of 100 μm-200 μm, the voltage applied to the modulator is at least 2V and an amplifier is therefore required that can produce a peak-value voltage of at least 2V. This necessity of providing an amplifier is disadvantageous from the standpoint of cost and miniaturization. Although the operating voltage can be decreased by increasing the modulator length, such a solution results in increase in the electrostatic capacitance C of the active layer section of the modulator and therefore prevents the realization of high-speed operation.

Further, the modulator-integrated light source must be kept at a uniform temperature to always obtain the maximum extinction ratio, and as a configuration for achieving this aim, a Peltier element must be mounted and a temperature regulating mechanism must be attached on the outside. This addition of a Peltier element is not only disadvantageous from the standpoint of cost and miniaturization, but further gives rise to a dramatic increase in power consumption of the overall device.

In the modulator-integrated light source disclosed in Document 3 as well, the high operating voltage of the modulator is disadvantageous from the standpoints of cost and miniaturization, as described above.

In addition, the above-described light sources are not of a semiconductor-embedded structure, but rather, of a ridge structure in which light cannot be adequately confined in the modulator absorption layer, and as a result, the absorption efficiency is low and the extinction ratio is poor. An extinction ratio of at least 10 decibels is normally demanded of a modulator-integrated light source, but the modulator-integrated light source such as disclosed in Document 3 has a low extinction ratio of just 6 decibels and has difficulty achieving an extinction ratio equal to or greater than 10 decibels.

It is an object of the present invention to provide a modulator-integrated light source that is both inexpensive and compact, that solves the above-described problems, that does not require an amplifier (driver) or temperature regulating mechanism, and that can obtain an extinction ratio of at least 10 decibels that is sufficient for use in optical communication, and further, to provide a fabrication method for such a modulator-integrated light source.

The modulator-integrated light source of the present invention for achieving the above-described object is a modulator-integrated light source in which: a semiconductor laser and an electroabsorption optical modulator are integrated on a high-resistance semiconductor substrate; the electroabsorption optical modulator has a pair of electrodes arranged on one surface of the high-resistance semiconductor substrate, a prescribed bias voltage being applied to these electrodes; and the electroabsorption optical modulator is of a configuration that satisfies the condition:
L×B≧200 μm·Gb/s

where L is the length of the electroabsorption optical modulator and B is the operating frequency.

As described above, when the electroabsorption optical modulator is integrated on a high-resistance substrate and is of a configuration such that a pair of electrodes (a P-electrode and an N-electrode) are positioned on the same substrate surface, the electrostatic capacitance of the electroabsorption optical modulator can be considered to be only the electrostatic capacitance of the active layer, and the modulation speed B (Gb/s) and modulator length L (μm) are therefore in an inversely proportional relation. In the case of this type of construction, the modulator length L is normally shortened to increase the modulation speed, but in the present invention, a configuration opposite to the normal case is adopted in which the modulator length L is increased. More specifically, in the case of a modulation speed of 10 Gb/s, instead of setting the modulator length L to under 200 μm as in the prior art, the modulator length L is set to at least 200 μm. By increasing the modulator length L in this way, light that is transmitted through the modulator can be more completely absorbed, whereby the present invention is capable of not only obtaining an extinction ratio of at least 10 dB, but of further allowing a configuration that does not require an amplifier (driver), i.e., allowing low-voltage operation in which the operating voltage is equal to or less than 1V.

Since the modulation bandwidth is necessarily reduced when the modulator length L is increased, the configuration of the present invention as described above would not be conceivable under ordinary circumstances. For example, the problem in the configurations in Documents 1 and 2 was the improvement of the modulation bandwidth, and increase of the modulator length was therefore not suggested. The present invention therefore is of a configuration that could not have been easily conceived based on the prior art.

The above-described modulator-integrated light source of the present invention may be of a configuration in which the absorption peak wavelength of the electroabsorption optical modulator is shorter than the oscillation wavelength of the semiconductor laser, and in which the energy conversion value ΔX of the detuning amount, which is the difference between the oscillation wavelength and the absorption peak wavelength at room temperature, satisfies the condition:
40 meV≦ΔX≦100 meV.

This configuration has effects as described hereinbelow.

Because the detuning amount (meV) was set to approximately 27-38 meV at room temperature in the prior art, the modulator could only operate in the vicinity of room temperature. In contrast, in the present invention, the detuning amount (meV) is set to at least 40 meV at room temperature. More specifically, the detuning amount (meV) at a room temperature of 20° C. is set to 43 meV that is greater than the prior art value of 30 meV. By means of this setting, the detuning amount in a high-temperature environment of, for example, 85° C. is approximately 30 meV, which is the ideal state for the operation of the modulator. On the other hand, in a low-temperature environment of 0° C., the detuning amount is 50 meV. In this case, superior extinction can be obtained by increasing the offset voltage. The present invention can thus provide a construction that does not require temperature regulation. Further, if the modulator length is set such that the value of the increased bias voltage is 1V or less when the temperature is low, the above-described low-voltage operation will not be lost.

The fabrication method of the modulator-integrated light source of the present invention is a method for fabricating a modulator-integrated light source in which a semiconductor laser and a electroabsorption optical modulator are integrated on a high-resistance semiconductor substrate, the method including: a first step of growing an active layer having a first bandgap in a region that includes the active layer of a semiconductor laser and an electroabsorption optical modulator; a second step of removing, of the active layer formed in the first step, the portion that corresponds to the region of the active layer of the electroabsorption optical modulator and taking the remainder as the active layer of the semiconductor laser; and a third step of growing an active layer having a second bandgap that differs from the first bandgap in the region that was removed in the second step as the active layer of the electroabsorption optical modulator.

According to the above-described fabrication method, the active layers of a semiconductor laser and electroabsorption optical modulator can be formed in separate steps, whereby the compositions, quantum well numbers, and bandgaps of each of these active layers can be optimized, and the formation of the modulator-integrated light source of the above-described present invention can be facilitated.

As described in the foregoing explanation, the present invention enables the realization of a configuration that does not require an amplifier (driver) at an extinction ratio of at least 10 dB, and thus enables lower power consumption, smaller size, and lower costs than the prior art.

In addition, the present invention enables a broader operating temperature range (for example, from 0°C. to 85° C.) than the prior art, and further, does not require a temperature control mechanism, and the present invention can therefore both enable lower power consumption and offer a corresponding reduction in size and costs.

### BRIEF DESCRIPTION OF THE DRAWINGS

FIG. 1 shows an example of the standard configuration of a modulator-integrated light source of the prior art;

FIG. 2A is an upper plan view of a modulator-integrated light source according to the first embodiment of the present invention;

FIG. 2B is a sectional view taken along line A-A of FIG. 2A;

FIG. 2C is a sectional view taken along line B-B of FIG. 2A;

FIG. 3 shows the relation between the modulator length and the offset bias voltage when the modulation speed is 10 Gb/s;

FIG. 4 shows the relation between the transmittance of a modulator in the absence of an electric field and the detuning amount, which is the wavelength difference between the oscillation wavelength of a distributed feedback laser and the absorption peak wavelength of the modulator;

FIG. 5A is an upper plan view of a modulator-integrated light source according to the second embodiment of the present invention;

FIG. 5B is a sectional view taken along line A-A of FIG. 5A; and

FIG. 6 is a sectional view of the modulator-integrated light source according to another embodiment of the present invention.

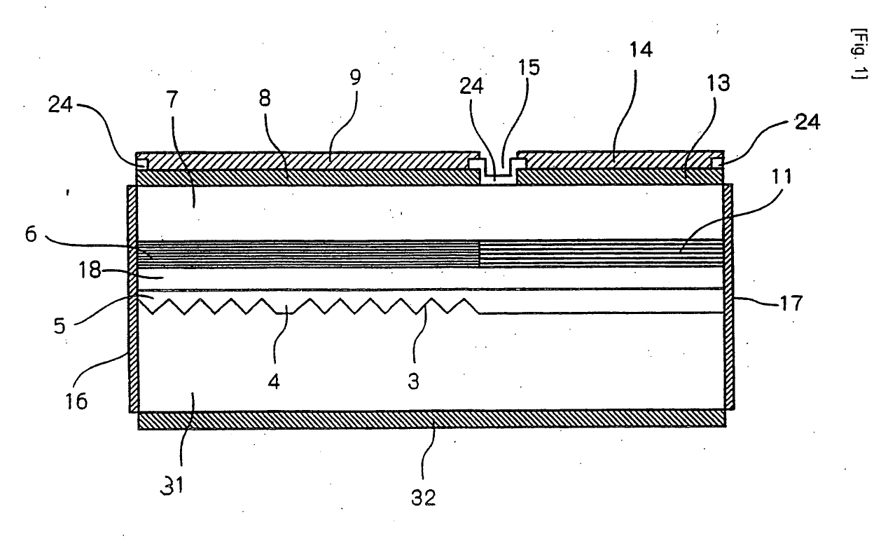

### EXPLANATION OF REFERENCE NUMBERS

1 high-resistance semiconductor substrate
1a distributed feedback laser section
1b optical modulator section
2 metallized layer
3 diffraction grating
4 λ/4 phase shift structure
5 waveguide layer
6,11 active layer section (quantum wells)
7 n-InP clad layer
8, 13 cap layers
9, 14 P-electrodes
15 electrode separator
16 high-reflection coating
17 low-reflection coating
18 n⁺-InP buffer layer
19 butt joint
20, 21 current block layers
22 traveling-wave electrode
23 undoped layer
24 SiO₂ film
25, 29, 30 pads
26-28 contact windows
31 n-InP substrate
32 N-electrode

### Mode for Carrying Out the Invention

Explanation next regards the details of embodiments of the present invention with reference to the accompanying figures.

### EMBODIMENT 1

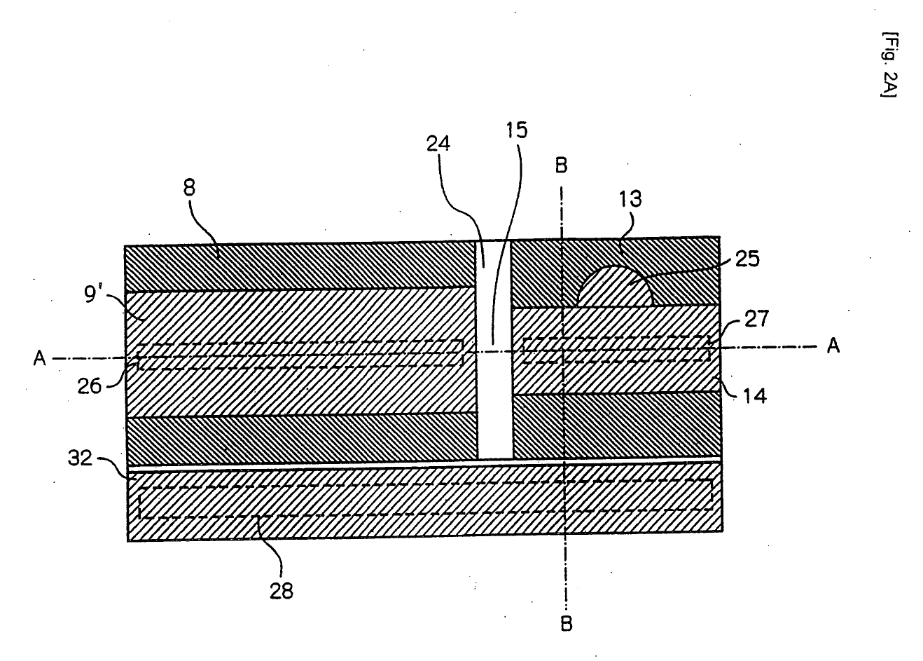

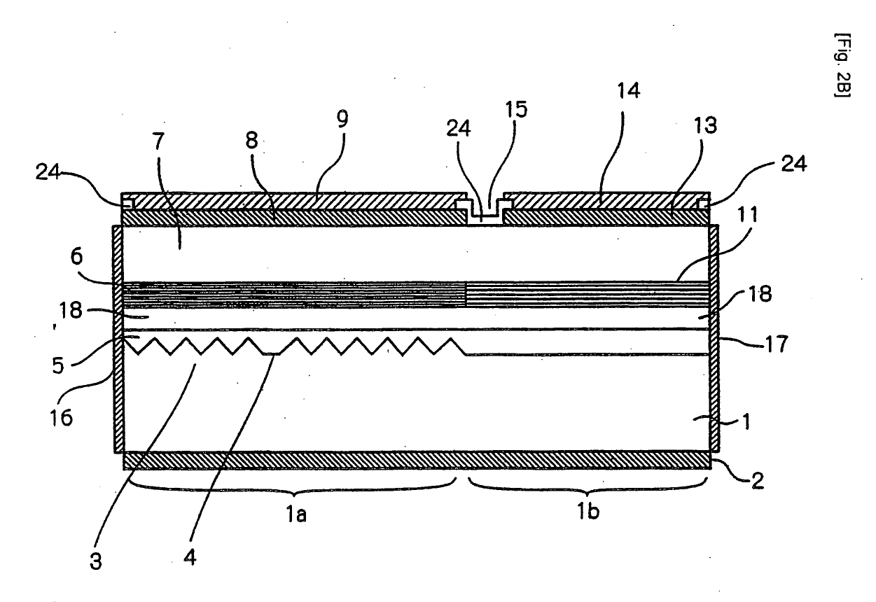

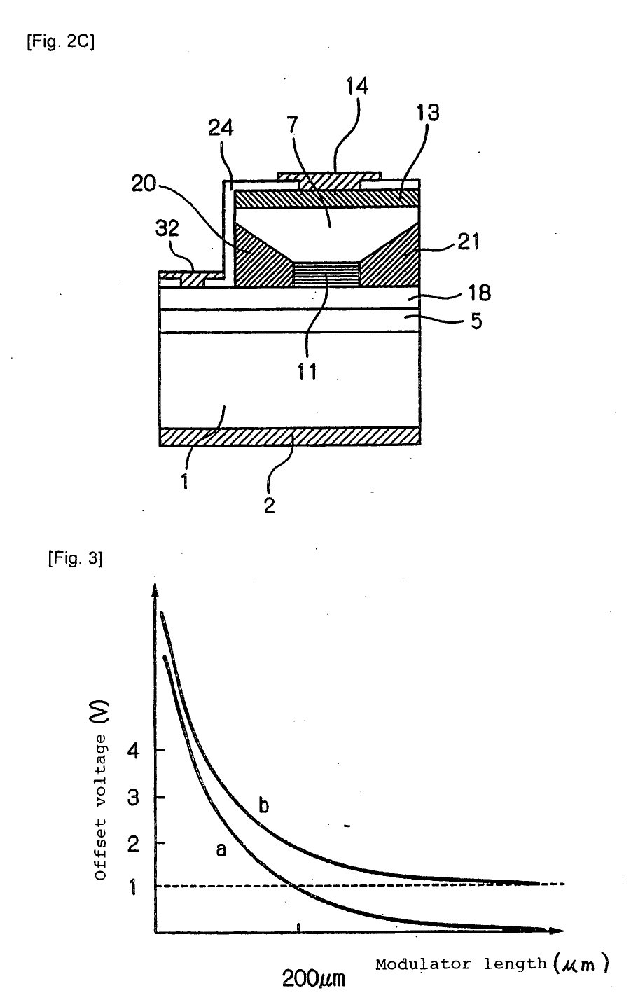

FIG. 2A is an upper plan view of the modulator-integrated light source according to the first embodiment of the present invention; FIG. 2B is a sectional view taken along line A-A of FIG. 2A; and FIG. 2C is a sectional view taken along line B-B of FIG. 2A.

Referring to FIGS. 2A-2C, distributed feedback laser section 1a and optical modulator section 1b are formed on the same high-resistance semiconductor substrate 1. High-resistance semiconductor substrate 1 is, for example, a high-resistance InP substrate, and more specifically, an InP substrate in which Iron (Fe) is a dopant. On high-resistance semiconductor substrate 1, a laminated structure composed of waveguide layer (light guide layer) 5, n⁺-InP buffer layer 18, an active layer section composed of quantum wells, and n-InP clad layer 7 is formed over the waveguide direction, with cleavage planes at both ends of this structure. High-reflection coating 16 is formed at one cleavage plane, and low-reflection coating 17 is formed at the other cleavage plane.

Diffraction grating 3, which is equipped with λ/4 phase shift structure 4, is provided in a portion of the boundary surface of high-resistance semiconductor substrate 1 and waveguide layer 5. In λ/4 phase shift structure 4, the phase shift positions may be either symmetrical or nonsymmetrical. A configuration is also possible in which this type of λ/4 phase shift structure 4 is not provided.

The active layer section is composed of active layer (quantum well) 6 of distributed feedback laser section 1 a and active layer (quantum well) 11 of optical modulator section 1b. Active layer 6 is positioned on diffraction grating 3. These active layers 6 and 11 are both known multi-quantum well structures but have bandgaps of different levels. In this case, the bandgap of the quantum wells of active layer 11 is made larger than the bandgap of the quantum wells of active layer 6.

Cap layer 8 is formed in the region of distributed feedback laser section 1a on n-InP clad layer 7, and cap layer 13 is formed in the region of optical modulator section 1b on n-InP clad layer 7. These cap layers 8 and 13 are covered by SiO₂ film 24. Contact window 26 is formed in the proximity of the center of the region of SiO₂ film on cap layer 8, and P-electrode 9 is formed to cover contact window 26. Similarly, contact window 27 is formed in the proximity of the center of the region of SiO₂ film 24 on cap layer 13, and P-electrode 14 is formed to cover this contact window 27. P-electrode 9 and P-electrode 14 are separated by electrode separator 15. Pad 25 for optical modulator electrode wiring is formed on one portion of P-electrode 14.

The portions of active layers 6 and 11, n-InP clad layer 7, and cap layers 8 and 13 that have been formed on n³⁰ -InP buffer layer 18 are in mesa shapes. Current block structures 20 and 21 are present in the portions located at the two sides of active layers 6 and 11 of the mesas. The ends of the mesas are covered by SiO₂ film 24. Contact window 28 is formed in the proximity of the center of the region of SiO₂ film 24 on n³⁰ -InP buffer layer 18, and N-electrode 32 is formed to cover contact window 28. N-electrode 32 and P-electrodes 9 and 14 are all formed on the same element surface, and are arranged so as not to confront each other. Metallized layer 2 is formed on the rear surface of n-InP substrate 31 to confront P-electrodes 9 and 14 and N-electrode 32.

In the modulator-integrated light source of the present embodiment, P-electrode 14 and N-electrode 32 are located on the same element surface, and moreover, high-resistance semiconductor substrate 1 is used as a substrate. By means of this configuration, the electrostatic capacitance of the modulator can be seen as only the electrostatic capacitance of active layer 11, and the modulation speed (Gb/s) and modulator length L (μm ) are in an inversely proportional relation. Although the modulator length is normally shortened to raise the modulation speed in a structure of this type, the present embodiment adopts a construction based on a technical idea that is opposite the ordinary concept, whereby lengthening the modulator length L such that more of the light that is transmitted through the modulator can be absorbed enables the realization of a construction that does not require an amplifier (driver), i.e., a construction that allows low-voltage operation in which the operating voltage is 1V or less. In this case, the modulator length L is the length in the direction of the waveguide of the region of active layer 11 that substantially absorbs the oscillation light from distributed feedback laser section 1a.

FIG. 3 shows the relation between the modulator length and the offset bias voltage (hereinbelow referred to as simply “offset voltage”) when the modulation speed is 10 Gb/s. In FIG. 3, the horizontal axis shows the modulator length (μm) and the vertical axis shows the offset voltage (V). Curve a relates to the modulator-integrated light source of the present embodiment, and curve b relates to a device of the prior art that does not use a high-resistance substrate.

In curve b, the offset voltage does not fall to 1V or less despite increase of the modulator length. In contrast, in curve a, the offset voltage falls to 1V or less when the modulator length is at least 200 μm. In other words, if the modulator length is made at least 200 μm, low-voltage operation of 1V or less becomes possible, and a configuration that does not require an amplifier (driver) can be realized. In the present embodiment, low-voltage operation is realized by setting the modulator length to at least 200 μm based on this information. More specifically, taking into consideration the inversely proportional relation between modulator length L and modulation frequency B, the modulator is constructed to satisfy the condition:
L×B≧2000 μm·Gb/s (Equation 1)

According to this configuration, the offset voltage is always 1V or less, and an amplifier is therefore unnecessary.

In the above-described Equation 1, the minimum value has special significance from the standpoint of realizing a configuration that does not require an amplifier. In addition, the maximum value of “L×B” is not subject to particular limitations, but is determined as appropriate according to the fabrication methods and design conditions. For example, since excessive modulator length L results in increased electrostatic capacitance C, the maximum value of “L×B” may be determined based on the CR limit. For example, when the modulation frequency B is 2.5 Gb/s, the element resistance R is 2Ω, the modulator length L is 2000 μm, and the thickness of the undoped layer is 0.2 μm, the CR time constant is 2.5 (picoseconds). To increase the degree of margin, if it is assumed that a time interval that is ten times this CR time constant is necessary for a one-bit pulse, 25 picoseconds, i.e., 40 Gb/s, is taken as the CR limit. Based on this CR limit, the existence of the maximum of “2000 μm×40 Gb/s” can be understood as the maximum of “L×B” in the above-described Equation 1. Thus, taking this maximum into consideration, the configuration is preferably realized to satisfy the condition:
2000 μm·Gb/s≦L×B≦80000 μm·Gb/s (Equation 2)

When the modulator length is made at least 200 μm, the increase in modulator length causes increase in the electrostatic capacitance, i.e., bandwidth deterioration, but the use of the high-resistance semiconductor substrate in the present embodiment results in a configuration that suppresses this type of bandwidth deterioration.

In addition, when the modulator is lengthened, the voltage amplitude for the operation of the modulator also exhibits the same downward trend as the offset voltage shown in FIG. 3. The offset voltage is normally assumed to be the voltage that can reduce light to one-half its intensity. This is because, when light is subjected to digital modulation (ON/OFF modulation), the response of the modulator to electrical signals is normally delayed and the emulation of the digital ON/OFF signals is consequently somewhat smoothed. The output signal waveform from the modulator oscillates to the ON and OFF sides centering on a voltage having ½ intensity, and this center voltage is therefore the offset voltage. The voltage amplitude for modulation operation is defined as, for example, the voltage necessary for cutting off light by extinguishing (cutting OFF) the light to 1/10 or 1/20 its original intensity. In this case, when the modulator length is increased to reduce the offset voltage, the voltage for cutting OFF light is similarly reduced. Accordingly, this trend toward reduction is the trend toward reduction with respect to modulator length similar to offset voltage in FIG. 3.

In addition to the above-described low-voltage operation, the modulator-integrated light source of the present embodiment is a configuration having a broader range of operation temperatures that does not require a temperature regulating mechanism. This configuration is described more specifically hereinbelow.

In the case of a low operating temperature, the absorption peak wavelength of the modulator makes a large shift to a shorter wavelength than the oscillation wavelength of the distributed feedback laser, resulting in degradation of the extinction ratio. In this case, a large bias voltage must be applied to obtain good extinction. When the operating temperature is high, on the other hand, the absorption peak wavelength of the modulator approaches the oscillation wavelength of the distributed feedback laser and the absorption of the modulator thus becomes large when an electric field is absent and the extinction ratio is degraded. In consideration of this temperature characteristic of detuning, in the present embodiment, the modulator length is set in advance in accordance with the above-described equation 1 such that a large bias voltage is not necessary at times of low temperature, and further, the detuning amount at times of room temperature (energy conversion value) is set in advance such that the modulator absorption does not become great at times of high-temperature operation.

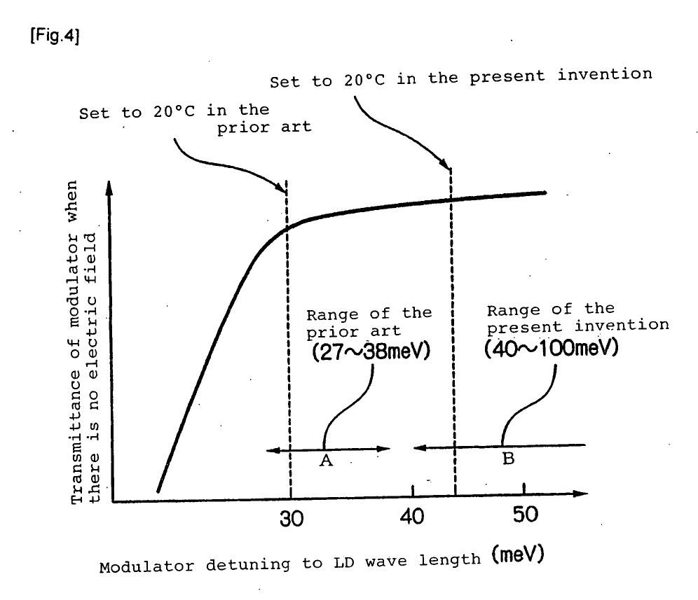

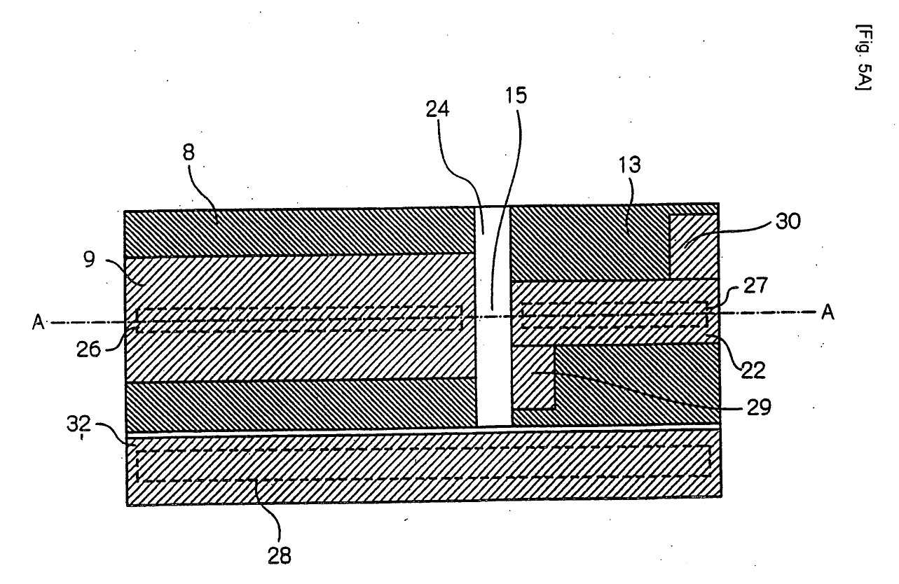

FIG. 4 shows the relation between the transmittance of the modulator when there is no electric field and the detuning amount (energy conversion value), which is the wavelength difference between the oscillation wavelength of the distributed feedback laser and the absorption peak wavelength of the modulator. In FIG. 4, the horizontal axis is the detuning amount (meV), and the vertical axis is the transmittance (%) of the modulator. The range indicated by arrow A is the setting range of the detuning amount in a device of the prior art, and the range indicated by arrow B is the setting range of the detuning amount in a device of the present embodiment.

In the device of the prior art, the detuning amount (meV) at room temperature was set to approximately 27-38 meV and the modulator therefore operated only in the vicinity of room temperature. In contrast, in the device of the present embodiment, the detuning amount (meV) at room temperature is set to at least 40 meV. More specifically, the detuning amount at room temperature 20° C. is set to a value of 43 meV that is higher than the 30 meV of the prior art. In this case, based on the temperature characteristic of detuning, the detuning amount is approximately 30 meV in a high-temperature environment of, for example, 85° C. A state in which this detuning amount is approximately 30 meV is ideal for the operation of the modulator. On the other hand, in a low-temperature environment of 0° C., the detuning amount is 50 meV. In this case, good extinction can be obtained by increasing the offset voltage. If the modulator length is set such that the increased bias voltage value is 1V or less at such times of low temperature, the above-described low-voltage operation will not be lost.

The upper limit of the detuning amount at room temperature is determined by the limit of occurrence of QCSE shift of the semiconductor material. More specifically, this limit is 100 meV at the energy conversion value of detuning. Thus, in the present embodiment, the energy conversion value ΔX of the detuning amount, which is the wavelength difference between the oscillation wavelength of distributed feedback laser section 1a and the absorption peak wavelength of optical modulator 1b, is set to satisfy the condition:
40 meV≦ΔX≦100 meV. (Equation 3)

Thus, in addition to the above-described low-temperature operation, by satisfying either of Equation 1 (or Equation 2) and Equation 3, the device of the present embodiment can realize non-temperature-modulation operation that does not require a temperature control mechanism for keeping the temperature of the modulator uniform. The minimum assumed operating temperature can be set to 0° C. or less, or alternatively, the maximum anticipated operating temperature can be set to, for example, 50° C. or more. In a device of the prior art in which the detuning amount at room temperature is set to approximately 30 meV, which is the ideal state for the operation of the modulator, a temperature control mechanism is necessary because good extinction cannot be obtained at temperatures higher than room temperature.

The following is a brief explanation of the fabrication procedure of the modulator-integrated light source shown in FIGS. 2A-2C.

First, diffraction grating 3 that includes λ/4 phase shift structure 4 is formed on high-resistance semiconductor substrate 1 by means of a known photolithographic method that uses an interference exposure method or an electron beam lithography method. The region in which this diffraction grating 3 is formed is only the region that operates as a distributed feedback laser.

Next, waveguide layer 5 composed of InGaAsP and n³⁰ -InP buffer layer 18 are successively formed over the entire surface, following which active layer 6 composed of InGaAsP/InGaAsP quantum wells and active layer 11 composed of InGaAsP/InGaAsP quantum wells are formed. Here, InGaAlAs can be used in place of InGaAsP. These active layers 6 and 11 are formed simultaneously by a known selective growth method such that the levels of the bandgaps differ. According to the selective growth method, SiO₂ masks are used to adjust the ultimate amount of formation or reduction and thus enable the supply of different amounts of raw material within the substrate surface and enable the formation of quantum wells of different thicknesses. In this way, the bandgap wavelengths of the quantum wells can be controlled within the substrate surface, whereby active layers can be formed such that the bandgap wavelengths differ in distributed feedback laser section 1a and modulator section 1b. Active layers 6 and 11 are formed such that the electrical conductivity characteristic of the active layers is undoped (high-resistance).

Current block layers 20 and 21 are next formed, following which P-InP clad layer 7 and cap layers 8 and 13 composed of P-InGaAs are successively formed over the entire surface. The vicinity of active layers 6 and 11 is next etched by a known wet etching method or a dry etching method to expose a portion of n³⁰ -InP buffer layer 18.

Next, SiO₂ film 24 is deposited over the entire surface and contact windows 26-28 are formed by etching. P-electrodes 9 and 14 and N-electrode 32 are then formed, and pads 25 are formed at the same time.

Finally, the rear surface of high-resistance semiconductor substrate 1 is polished to a thickness of approximately 100 μm, and metallized layer 2 is then formed by vapor deposition of a metal on the polished surface.

Although active layers 6 and 11 are formed by selective growth methods in the above-described fabrication steps, the present invention is not limited to this form. Active layers 6 and 11 can be formed by a butt joint method. In a butt joint method, an active layer that includes a first bandgap is first grown over the entire surface (including the regions of active layers 6 and 11). A portion of the region of active layer 11 is then removed by a known wet etching method or a dry etching method to obtain active layer 6. An active layer having a second bandgap that differs from the first bandgap is then grown in only this removed portion to obtain active layer 11. According to this butt joint method, active layers 6 and 11 can each be formed in different steps, whereby the compositions, the quantum well numbers, and the bandgaps of each of active layers 6 and 11 can be independently set to enable easy optimization.

Through the use of the above-described butt joint method, the active layer structures of distributed feedback laser section 1a and modulator section 1b can be independently controlled, whereby a type-II structure can be applied in the quantum wells of the modulator. A brief explanation of the type-II structure follows below.

Two structures, type-I and type-II, are know as quantum well structures. A type-I quantum well refers to a structure in which the energy level of the conductive band of the well is higher than the energy level of the conductive band of the barrier, and moreover, the energy level of the valence band of the well is lower than the energy level of the valence band of the barrier. Normally, both electrons and positive holes are confined within the well. On the other hand, a type-II quantum well refers to a case in which the relation of the energy levels of the conductive bands is the same as in the type-I structure, but the energy level of the valence band of the well is higher than the energy level of the valence band of the barrier.

In a type-II quantum well, positive holes are confined in the well but electrons are not confined within the well, and as a result, the quantum well is of a structure that is not normally capable of absorbing light. However, when a reverse bias voltage is applied to a type-II quantum well, the energy level inclines and the electrons that are confined in the barrier act to enable absorption of light. The extinction ratio (ON/OFF ratio) of light in such a type-II quantum well before and after the application of a reverse bias voltage is greater than in a type-I quantum well. Accordingly, the application of this type-II quantum well structure in the active layer of the modulator allows a higher extinction ratio to be obtained.

A type-II quantum well can be easily formed by using a composition in which the energy level of the valence band rises in the quantum well composition. A type-II quantum well that includes an InP barrier in a well composed of InAlAs such as described in Japanese Patent No. 3001365 can be used as the type-II quantum well.

### EMBODIMENT 2

A traveling-wave electrode structure can also be adopted for the electrodes of the optical modulator in the modulator-integrated light source of the first embodiment. Explanation here regards a modulator-integrated light source having this traveling-wave electrode structure.

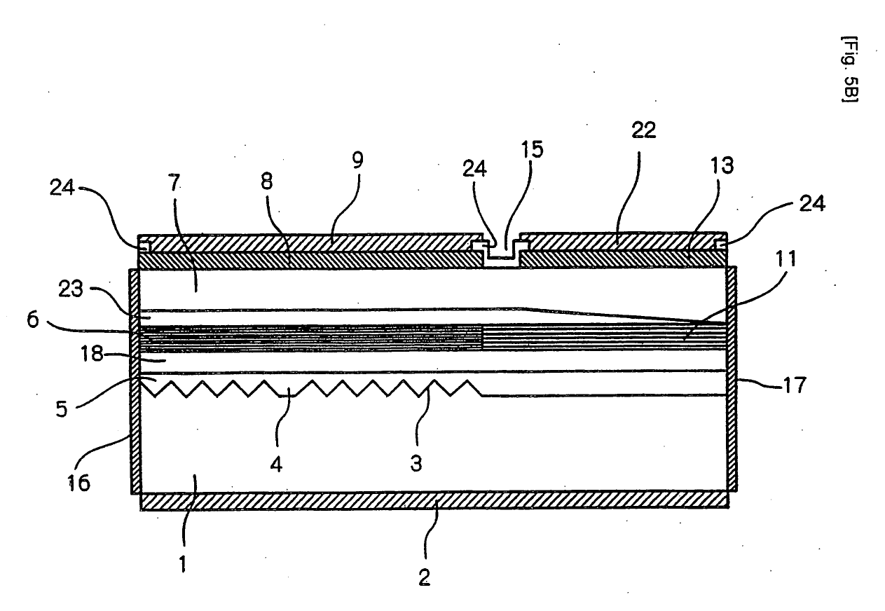

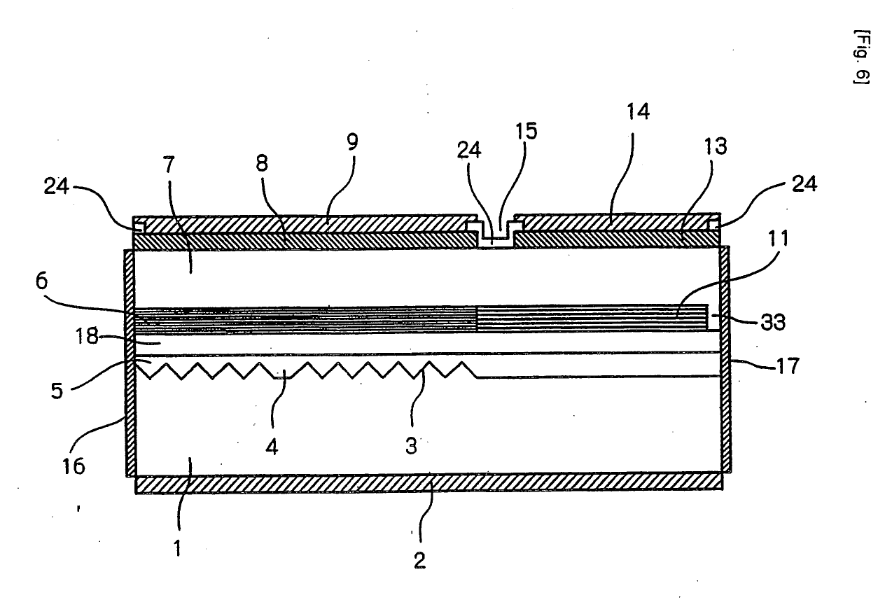

FIG. 5A is an upper plan view of the modulator-integrated light source according to the second embodiment of the present invention, and FIG. 5B is a sectional view taken along line A-A of FIG. 5A. In FIG. 5A and FIG. 5B, elements that are the same as elements shown in FIGS. 2A-2C are given the same reference numbers. In the interest of avoiding redundant explanation, explanation here regards only the distinguishing features of the second embodiment.

The modulator-integrated light source of the present embodiment is of a configuration in which P-electrode 14 of modulator section 1b in the modulator-integrated light source shown in FIGS. 2A-2C is replaced by traveling-wave electrode 22, and further, undoped InP layer 23 is provided on active layers 6 and 11. In the present embodiment as well, a configuration that does not require an amplifier or a temperature control mechanism is realized by satisfying the previously described conditions of Equation 1 (or Equation 2) and Equation 3.

Traveling-wave electrode 22 is an electrode structure in which a supplied modulation electrical signal progresses from the first end on the electrode separator 15 side and toward the second end located on the opposite side. Pad 29 for traveling-wave electrode wiring is formed on the first end side of traveling-wave electrode 22, and pad 30 for traveling-wave electrode wiring is formed on the second end side. By means of this electrode structure, the modulation electrical signal advances in the same direction as the direction of progression of light, whereby the modulator signal can be caused to act more effectively upon the light regardless of the capacitance of active layer 11 and the modulation efficiency can be improved.

Undoped InP layer 23 is formed in a uniform film thickness in the region on active layer 6, and is formed in a thickness that gradually decreases with progression toward the side of low-reflection coating 17 in the region on active layer 11, i.e., in the region located below traveling-wave electrode 22.

In the modulator, the thickness of undoped InP layer 23 that is interposed between an n-type semiconductor and p-type semiconductor has a great influence upon the characteristics of the modulator. Normally, the modulator realizes light extinction through the application of a reverse bias voltage to a p-n diode. The reverse bias voltage produces an electric field in the undoped (high-resistance) active layer of the modulator, and the greater this electric field, the greater the light extinction that can be realized. It is believed that in traveling-wave electrode 22, field strength ideally remains unchanged as an electromagnetic wave for modulation progress through the electrode, but in actuality, the occurrence of impedance mismatching between traveling-wave electrode 22 and the transmission lines that lead to traveling-wave electrode 22 causes the field strength of the modulation electromagnetic wave to attenuate as the modulation electromagnetic wave progresses through the traveling-wave electrode. As a result, the light extinction characteristic of the latter half of the modulator exhibits a high level of degradation compared to the first half of the modulator. In order to mitigate this degradation of the light extinction characteristic in the latter half of the modulator, attenuation of the field strength produced in the active layer of the modulator section must be prevented even though the voltage of the electromagnetic wave decreases.

The relation between the voltage of the electromagnetic wave and the total thickness of undoped InP layer 23 is given by:
E=V/d (Equation 4)
where E is the field produced in undoped InP layer 23, V is the voltage of the electromagnetic wave, and d is the thickness of undoped InP layer 23. According to Equation 4, decreasing thickness d can keep field E uniform despite decrease in voltage V. When impedance mismatching occurs between traveling-wave electrode 22 and the transmission lines leading up to traveling-wave electrode 22, the voltage attenuates as the electrical signal progresses through traveling-wave electrode 22, but the field produced in the active layer does not attenuate. As a result, in the present embodiment, the field is kept uniform and the light extinction characteristic is increased by decreasing the thickness of undoped InP layer 23 in the direction of progression.

According to the modulator-integrated light source of the present embodiment, a traveling-wave electrode is adopted as the electrode of the optical modulator, and as a result, the modulator-integrated light source of the present embodiment features a multiplication of effects by enabling a virtually ideal elimination of the electrostatic capacitance of the absorption layer MQW of the modulator and a boosting of the operation modulation bandwidth. A traveling-wave electrode such as described in Japanese Patent No. 2996287 can be used as traveling-wave electrode 22.

In the present embodiment, moreover, the thickness of undoped InP layer 23 in the modulator section is gradually decreased in the direction of progression of oscillation light as shown in FIG. 5B. The adoption of this form has the effects of enabling compensation of voltage that attenuates with progression and preventing degradation of the light extinction characteristic of the modulator. A configuration in which the thickness of undoped InP layer 23 in the modulator section is modified can be realized by adjusting the amount of diffused zinc, which is a p-type dopant, in the direction of the waveguide.

In the modulator-integrated light sources according to each of the above-described embodiments, the configuration can be modified as appropriate within a scope that does not depart from the spirit of the invention. For example, the distributed feedback laser that is integrated on the high-resistance semiconductor substrate may be another semiconductor laser.

In addition, to improve the reliability of the elements and reduce the operating voltage of the modulator section, the active layers may be formed from a buried structure that uses a semiconductor or dielectric in place of the ridge waveguide structure described in Document 3. The buried structure may further be an undoped layer (high-resistance layer). Such a buried structure can be realized by a selective growth method.

Still further, an aluminum material having good temperature characteristics may be used in the active layer of the modulator. An InGaAsP material is normally used in the semiconductor laser and modulator. However, because this is a material in which the energy difference ΔEc between the energy level of the valence band of a barrier and the energy level of the valence band of a well is small, electrons overflow from wells during operation in a high-temperature environment, resulting in a drop in light output. To prevent this result, the use of an aluminum, material such as InGaAlAs or InAlAs produces a two-fold improvement in the ΔEc compared to an InGaAsP material and can suppress the overflow of electrons from wells. As a result, the decrease in light output during operation in a high-temperature environment can be suppressed. In this way, the use of an aluminum material results in a multiplication of effects for improving the temperature characteristic of a distributed feedback laser, and operation at higher temperatures is thus possible.

In addition, a current block layer may be formed from a high-resistance buried layer to reduce the residual electrostatic capacitance of the current block layer. This form allows a reduction of the proportion of the current that flows through the vicinity of the active layers without flowing through the active layers and therefore can suppress decrease in the light output of the semiconductor laser when operating in a high-temperature environment. A high-resistance buried layer in which a high-resistance InP layer and an n-type InP layer are continuously buried and formed by an MOCDV (metal organic chemical vapor deposition) method such as described in JP-A-2000-353848 can be used as the high-resistance buried layer.

In addition, window structure 33 may be provided between active layer 11 of optical modulator section 1b and low-reflection coating 17 as shown in FIG. 6 such that active layer 11 of optical modulator 1b and low-reflection coating 17 do not come into contact. By means of this construction, light that is emitted from the end of active layer 11 is diffused by window structure 33, whereby the amount of light that is reflected by low-reflection coating 17 and returned into active layer 11 can be dramatically reduced. In addition, the window structure shown in FIG. 6 is an example that has been applied to the construction of the first embodiment, but this window structure can also be applied to the construction of the second embodiment.

### UTILIZATION IN INDUSTRY

The present invention can be applied in mid- and long-distance light sources used in main line systems or access systems, or in modulator-integrated light sources that are used in data communication systems or end-user terminals.

1-11. (canceled)

12. A modulator-integrated light source in which a semiconductor laser and an electroabsorption optical modulator are integrated on a high-resistance semiconductor substrate;
wherein said electroabsorption optical modulator has a pair of electrodes arranged on one surface of said high-resistance semiconductor substrate and a prescribed bias voltage is applied to said electrodes;
said electroabsorption optical modulator is of a configuration that satisfies a condition:
L×B≧2000 μm·Gb/s
where L is a length of said electroabsorption optical modulator and B is an operating frequency;
an absorption peak wavelength of said electroabsorption optical modulator being shorter than an oscillation wavelength of said semiconductor laser; and
the energy conversion value ΔX of a detuning amount, which is the difference between said oscillation wavelength and said absorption peak wavelength at room temperature, satisfies a condition:
40 meV≦ΔX≦100 meV.

13. A modulator-integrated light source according to claim 12, wherein said prescribed bias voltage applied at a minimum operating temperature is 1 V or less.

14. A modulator-integrated light source according to claim 12, wherein said pair of electrodes are a P-type electrode and an N-type electrode, and said P-type electrode is a traveling-wave electrode.

15. A modulator-integrated light source according to claim 14, wherein an active layer of said electroabsorption optical modulator has an undoped layer and a thickness of said undoped layer gradually decreases with progression in a direction of progression of oscillation light from said semiconductor laser.

16. A modulator-integrated light source according to claim 12, wherein active layers of said semiconductor laser and said electroabsorption optical modulator are composed of layers buried by a semiconductor or a dielectric.

17. A modulator-integrated light source according to claim 16, wherein said buried layers are undoped layers.

18. A modulator-integrated light source according to claim 12, wherein quantum wells of an active layer of said semiconductor laser and quantum wells of an active layer of said electroabsorption optical modulator are joined by a butt joint.

19. A modulator-integrated light source according to claim 18, wherein the quantum wells of said electroabsorption optical modulator are of a structure wherein an energy level of a conductive band of wells is higher than an energy level of a conductive band of the barriers, and moreover, an energy level of a valence band of the wells is higher than an energy level of a valence band of the barriers.

20. A modulator-integrated light source according to claim 12, wherein aluminum is contained in a composition of the active layer of said electroabsorption optical modulator.

21. A fabrication method of a modulator-integrated light source in which a semiconductor laser and an electroabsorption optical modulator are integrated on a high-resistance semiconductor substrate; said fabrication method comprising the steps of:
growing an active layer having a first bandgap in a region that includes active layers of said semiconductor laser and said electroabsorption optical modulator;
removing, of the active layer formed in said growing step, the portion that corresponds to the region of the active layer of said electroabsorption optical modulator and using a remainder as the active layer of said semiconductor laser; and
growing an active layer having a second bandgap that differs from said first bandgap in a region that was removed in said removing step as the active layer of said electroabsorption optical modulator.
